(19) United States
(12) Patent Application Publication
(10) Pub. No.: US 2011/0044050 A1
(43) Pub. Date: Feb. 24, 2011

(54) LED LAMP HAVING GOOD HEAT DISSIPATING EFFICIENCY AND SECURITY

(76) Inventor: Hua-Jung CHIU, Jhongli City (TW)

Correspondence Address: Muncy, Geissler, Olds & Lowe, PLLC, 4000 Legato Road, Suite 310, FAIRFAX, VA, 22033, US

(21) Appl. No.: 12/544,634

(22) Filed: Aug. 20, 2009

(51) Int. Cl. F21V 29/00

(52) U.S. Cl. 362/294

(57) ABSTRACT

An LED lamp having good heat dissipating efficiency and security includes a heat dissipating body, an optics unit, a driving unit, a cover, a socket, and a heat preventing element. The heat dissipating body has a plurality of fins, a fixing groove, and a heat dissipating groove. The fins are disposed around the heat dissipating body. The fixing groove is formed around the outside of fins. The heat dissipating groove is formed around the inside of fins for dissipating heat. The optics unit and the driving unit are accommodated in the heat dissipating body. The heat preventing element is disposed in the fixing groove. As a result, the improved LED lamp can dissipate heat easily and quickly, and protect users from getting hurt.

### BACKGROUND OF THE INVENTION

1. Field of the Invention

The present invention relates to a LED lamp, and in particular to an improved LED lamp having good heat dissipating efficiency and security.

2. Description of Related Art

Light emitting diode (LED) are used in many applications such as lamps, flat screen displays and devices to provide illumination. LED are small, inexpensive, low power, etc., so more and more LED with different capabilities are being developed.

LED for use in a display or an illumination device require many LEDs, and most of the LEDs are driven at the same time, which results in a quick rise in temperature of the LED device. Since general LED device does not have heat sinks with good heat dissipating efficiencies, operation of general LED are often erratic and unstable because of the rapid build up of heat. Consequently, the light from the LED often flickers that causes degradation of quality of the display or illumination. Besides, the body of the LED device would still keep a high temperature when it turned off in a short while ago. If users take the LED device, they will get hurt easily.

In order to overcome the above problems, the present Inventor proposes a novel and reasonable structure based on his delicate researches and expert experiences.

### SUMMARY OF THE INVENTION

The objective of the present invention is to provide an improved LED lamp having good heat dissipate efficiency and security, which can easily and quickly dissipate heat and protect users from getting hurt.

The present invention provides a LED lamp having good heat dissipating efficiency and security, which includes: a heat dissipating body having a plurality of fins, a fixing groove, and a heat dissipating groove, the fins being disposed around the heat dissipating body, the fixing groove being formed around the outside of fins, the heat dissipating groove being formed around the inside of fins for dissipating heat; an optics unit being disposed in the heat dissipating body, the optics having a lens and a LED which is disposed under the lens; a driver unit being disposed in the heat dissipating body and electrically connected with the LED; a cover being disposed under the driver unit; a socket being disposed under the cover; and a heat preventing element being disposed in the fixing groove for protecting user from getting hurt.

The present invention has advantageous features as follows. The heat dissipating groove is formed around the inside of fins. With this arrangement, it can guide air into the heat dissipating body to dissipate heat efficiently. The heat preventing element is disposed in the fixing groove. With this arrangement, it can protect users from getting hurt.

In order to further understand the characteristics and technical contents of the present invention, a description relating thereto will be made with reference to the accompanying drawings. However, the drawings are illustrative only but not used to limit the present invention.

### BRIEF DESCRIPTION OF THE DRAWINGS

FIG. 1 is a schematic view showing the LED lamp of the present invention;

FIG. 2 is an exploded perspective view showing the LED lamp of the present invention;

FIG. 3 is an another perspective view showing the LED lamp of the present invention;

FIG. 4 is a cross section view showing the LED lamp of the present invention; and

FIG. 5 is an another embodiment showing the LED lamp of the present invention.

### DETAILED DESCRIPTION OF THE PREFERRED EMBODIMENTS

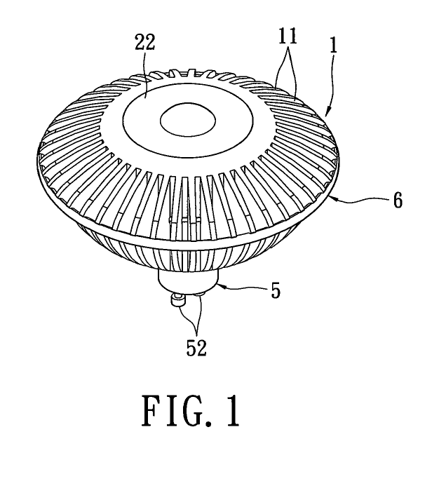

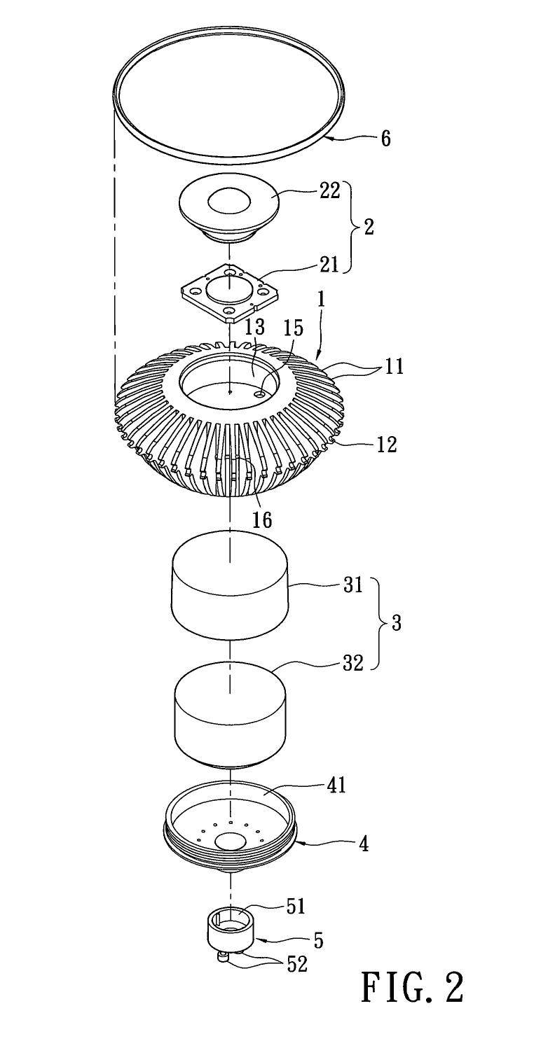

Please refer to FIGS. 1 to 4. The present invention provides an improved LED lamp, which includes a heat dissipating body 1, an optics unit 2, a driving unit 3, a cover 4, a socket 5 and a heat preventing element 6.

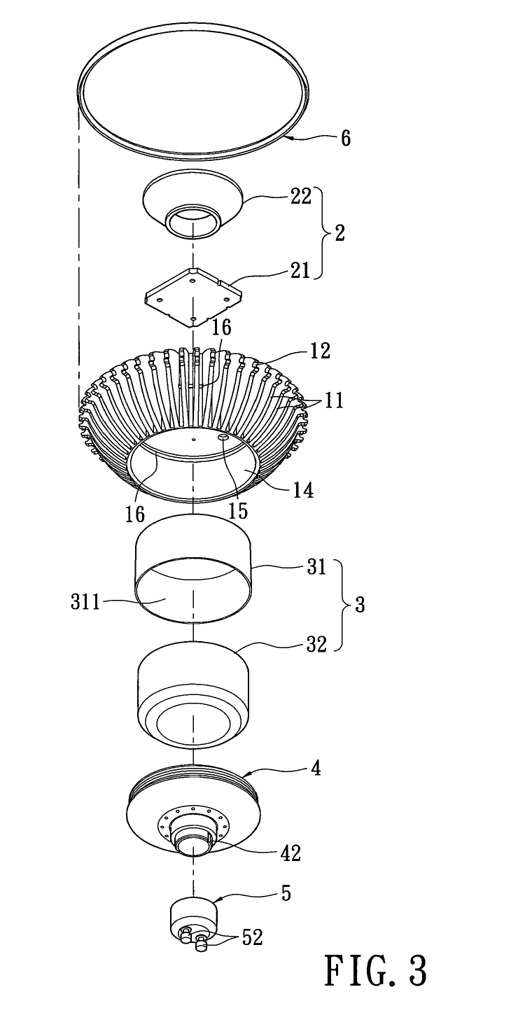

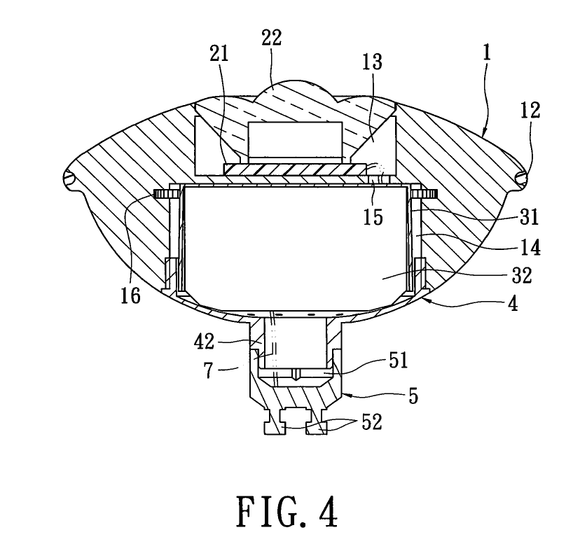

The heat dissipating body 1 is shaped into a circle and has high thermal conductivity. In this embodiment, the heat dissipating body 1 has a plurality of fins 11, a fixing groove 12, a first accommodating space 13, a second accommodating space 14, and a heat dissipating groove 16. The fins 11 are located around the heat dissipating body 1 and shaped into a radiate shape. The fixing groove 12 is shaped into a ring and formed around the outside of fins 11 for fixing the heat preventing element 6. A through hole 15 is connected with the first accommodating space 13 and the second accommodating space 14. The heat dissipating groove 16 is for dissipating heat. Please refer to FIGS. 3 and 4, the heat dissipating groove 16 is shaped into a ring and formed around the inside of the fins 11. The heat dissipating groove 16 can guide air into the heat dissipating body 1 to dissipate heat generated from the optics unit 2 efficiently.

The optics unit 2 is disposed in the first accommodating space 13 of the heat dissipating body 1. The optics unit 2 has a LED 21 and a lens 22. The power of LED is about 10 w. The shape of LED 21 is a rectangle. The center of the LED 21 is a radiating portion. The LED 21 is disposed under the lens 22. The lens 22 is made of light pervious material. The lens 22 is shaped into a crown and can diffuse the light radiated from the LED 21.

The driving unit 3 is disposed in the second accommodating space 14 of the heat dissipating body 1. In this embodiment, the driving unit 3 has a driver box 31 and a driver 32. The driver 32 is accommodated in the driver box 31 and electrically connected with the LED 21 via an electric line 7.

The cover 4 is made of plastics. In this embodiment, the cover 4 is screwed with the inner wall of the second accommodating space 14, but it is not limited to that manner. The cover 4 has a concave groove 41 up and a connecting portion 42 down. The driving units 3 is held in the concave groove 41. The connecting portion 42 is protruded downwardly and shaped into a hollow cylinder.

In this embodiment, the socket 5 is a type of GU10. The socket 5 has a connecting groove 51 up and two pins 52 down. The shape of the connecting groove 51 is according to the connecting portion 42 of the cover 4. The connecting portion 42 is disposed in the connecting groove 51. The two pins 52 are made of metal. The two pins 52 are electrically with the driver 32 via an electric line 7. The two pins 52 can be inserted to a connector (not shown in FIGS.) to conduct electric power.

In this embodiment, the heat preventing element 6 is made of silica gel and shaped into a ring. The heat preventing element 6 is disposed in the fixing groove 12 for protecting user from getting hurt from heat and protecting users' security.

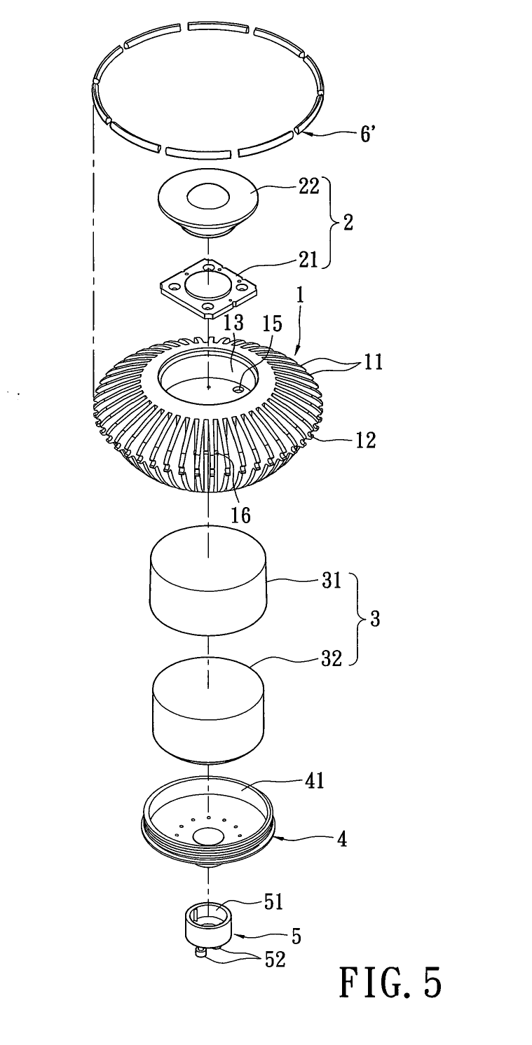

Please refer to FIG. 5, it shows an another embodiment of the present invention. The difference of the embodiment is that the heat preventing element 6 has a plurality of sections. The sections are located in the fixing groove 12 with an interval.

The present invention has advantageous features as follows. The heat dissipating groove 16 is formed around the inside of fins 11. With this arrangement, it can guide air into the heat dissipating body 1 to dissipate heat efficiently. The heat preventing element 6 is disposed in the fixing groove 12. With this arrangement, it can protect users from getting hurt and save users security.

The above-mentioned descriptions represent merely the preferred embodiments of the present invention, without any intention to limit the scope of the present invention thereto. Various equivalent changes, alternations or modifications based on the claims of present invention are all consequently viewed as being embraced by the scope of the present invention.

What is claimed is:

1. An LED lamp having good heat dissipating efficiency and security, comprising:
a heat dissipating body having a plurality of fins, a fixing groove, and a heat dissipating groove, the fins being disposed around the heat dissipating body, the fixing groove being formed around the outside of fins, the heat dissipating groove being formed around the inside of fins for dissipating heat;
an optics unit being disposed in the heat dissipating body, the optics unit having a lens and a LED which is disposed under the lens;
a driver unit being disposed in the heat dissipating body and electrically connected with the LED;
a cover being disposed under the driver unit;
a socket being disposed under the cover; and
a heat preventing element being disposed in the fixing groove for protecting user from getting hurt.

2. The LED lamp having good heat dissipating efficiency and security according to claim 1, wherein the heat dissipating body has a first accommodating space and a second accommodating space, the optics unit is disposed in the first accommodating space, the driving unit and part of the cover are disposed in the second accommodating space.

3. The LED lamp having good heat dissipating efficiency and security according to claim 2, wherein a through hole is connected between the first accommodating space and the second accommodating space.

4. The LED lamp having good heat dissipating efficiency and security according to claim 2, wherein the cover is screwed with the inner wall of the second accommodating space.

5. The LED lamp having good heat dissipating efficiency and security according to claim 1, wherein the driving unit comprises a driver box and a driver, the driver is accommodated in the driver box and electrically connected with the LED.

6. The LED lamp having good heat dissipating efficiency and security according to claim 1, wherein the heat dissipating groove is shaped into a ring.

7. The LED lamp having good heat dissipating efficiency and security according to claim 1, wherein the cover has a concave groove and a connecting portion, the driving unit is located in the concave groove.

8. The LED lamp having good heat dissipating efficiency and security according to claim 7, wherein the socket has a connecting groove and two pins, the connecting portion is fixed to the connecting groove, the two pins are electrically connected with the driving unit.

9. The LED lamp having good heat dissipating efficiency and security according to claim 1, wherein the heat preventing element is made of silica gel and has a plurality of sections, the sections are located in the fixing groove with an interval.

10. The LED lamp having good heat dissipating efficiency and security according to claim 1, wherein the fins are shaped into a radiate shape.
